(19) United States
(12) Patent Application Publication
(10) Pub. No.: US 2010/0330448 A1
(43) Pub. Date: Dec. 30, 2010

(54) Fuel cell power plant having improved operating efficiencies

(76) Inventors: Michael L. Perry, Glastonbury, CT (US); Robert M. Darling, South Windsor, CT (US)

Correspondence Address: Malcolm J Chisholm Jr, P O Box 278, Lee, MA, 01238, US

(21) Appl. No.: 12/735,672

(22) PCT Filed: May 7, 2008
(86) PCT No.: PCT/US2008/005873

§ 371 Date: Aug. 6, 2010

(51) Int. Cl. H01M 8/04

(52) U.S. Cl. 429/434

(57) ABSTRACT

A fuel cell power plant (10) includes an oxidant stream controlled to enter a fuel cell (12) of the plant at a pressure of between about 0.058 pounds per square inch gas (‘psig’) and about 4.4 psig and the oxidant stream passes through the fuel cell (12) at an oxidant stoichiometry of between about 120% and about 180%, and preferably between about 150% and 170%. A macro-pore cathode gas diffusion layer (36) is secured between a cathode catalyst (16) and a cathode flow field (28). A porous coolant plate (44) is secured in fluid communication with and adjacent the cathode flow field (28). The gas diffusion layer (36) and coolant plate (44) facilitate removal of product water to eliminate flooding and to permit operation at low oxidant stoichiometry and high water balance temperature, thereby minimizing need for water capture and heat rejection apparatus.

### TECHNICAL FIELD

The present disclosure relates to fuel cell power plants that are suited for usage in transportation vehicles, portable power plants, or as stationary power plants, and the disclosure especially relates to a fuel cell power plant that operates efficiently at low oxidant stoichiometries and low pressure drop, and that thereby minimizes need for water recovery devices, heat rejection apparatus and complex pressure control valves.

### BACKGROUND ART

Fuel cells are well known and are commonly used to produce electrical current from hydrogen containing reducing fluid fuel and oxygen containing oxidant reactant streams to power electrical apparatus such as transportation vehicles. As is well known in the art, a plurality of fuel cells are typically stacked together to form a fuel cell stack assembly which is combined with controllers, thermal management systems, and other components to form a fuel cell power plant.

In fuel cells of the prior art considerable effort is directed to operating a fuel cell in water balance. Operating in water balance essentially means that product water generated by the fuel cell is adequate to maintain sufficient water content of an electrolyte of a fuel cell, such as a “proton exchange membrane” (“PEM”) electrolyte, and is adequate to properly humidify reactant streams. If the fuel cell operates in water balance, no additional water has to be added to efficiently support the fuel cell. As is well known, fuel cell product water may accumulate within a reactant flow field adjacent a cathode electrode of the fuel cell. Typically, the oxidant stream passing through the reactant flow field will remove most of such product water as water vapor or entrained droplets. However, if a rate of removal of such water is inadequate, accumulated water will restrict flow of the oxidant stream effectively flooding a portion of the fuel cell causing decreased performance of the cell. Additionally, heat generated during operation of the fuel cell increases a temperature of the oxidant stream, thereby increasing the amount of water the oxidant stream may remove as the stream moves through the fuel cell.

Known efforts to efficiently operate a fuel cell have typically included a high flow rate or high pressure drop of the oxidant stream passing through tortuous or serpentine flow channels adjacent solid flow field plates to remove adequate fuel cell product water to avoid flooding of the flow channels. It is also known to permit the oxidant stream to steadily increase in temperature as the oxidant stream moves through the fuel cell, such as by co-flowing a coolant stream adjacent the oxidant stream. This results in the heated oxidant stream removing increasing amounts of water vapor as the stream moves through the fuel cell. While such operating approaches produce enhanced fuel cell electrical current production, the high oxidant stream flow rate and high temperature of the stream typically result in excess water moving out of the cell, thereby forcing the cell out of water balance.

An oxidant exhaust stream exiting such a fuel cell is hot and burdened with water, and is typically processed through water capture apparatus, such as a condenser or an enthalpy recovery device, to return water to the fuel cell. Additionally, such fuel cells will also require a relatively large heat rejection device, such as a radiator, to cool down either or both of the oxidant exhaust stream and a circulating coolant stream. Such heat rejection devices are relatively large because fuel cells operate at relatively low temperatures (for example, relative to internal combustion engines). These fuel cells also require complex and costly oxidant compressors or pumps and related pressure valve control apparatus to maintain high pressure and flow rates of reactant streams passing through the fuel cells.

An example of such a fuel cell is disclosed in U.S. Pat. No. 5,879,826 that issued to Lehman et al. on Mar. 9, 1999. Lehman et al. disclose that efficient operation of their fuel cell requires an air stoichiometry of between 200-300% and specifically states that fuel cell performance falls off significantly at stoichiometries below 200% because the rate of air flow through the fuel cell is insufficient to remove product water, thereby resulting in flooding of the fuel cell. (For purposes herein, the phrase “stoichiometry of ______% (such as 200%) is to mean the stated percentage of a required amount of a compound, wherein the “required amount of the compound” results in a perfectly efficient reaction that consumes all reactants through the reaction. For example, an oxidant stream stoichiometry of 200% is to mean that twice as much oxygen, or 100% more oxygen, is directed through the fuel cell than is needed to react with perfect efficiency with the hydrogen reactant to produce water at a given current. An oxidant stoichiometry of 200% results in one-half of the oxygen not being utilized within the fuel cell.) To maintain an oxidant stream stoichiometry between 200-300%, Lehman et al. must cool down or somehow recapture the water leaving the fuel cell within all of the excess air. This results in use of costly and complex apparatus necessary to maintain the fuel cell in water balance.

### SUMMARY

The disclosure includes a fuel cell power plant for generating electrical current from oxidant and hydrogen rich reactant streams, wherein an oxidant stream enters a fuel cell of the plant at a pressure of between about 0.058 pounds per square inch gas (“psig”) and about 4.4 psig and the oxidant stream passes through the fuel cell at an oxidant stoichiometry of between about 120% and about 180%, and preferably between about 150% and about 170%. (For purposes herein, the word “about” is to mean plus or minus 20%.)

The power plant includes, at least one fuel cell having an anode catalyst and a cathode catalyst secured to opposed sides of an electrolyte. An anode flow field is defined in fluid communication with the anode catalyst and with a source of the hydrogen rich reactant for directing flow of the hydrogen rich reactant from an anode flow field inlet, adjacent the anode catalyst and out of the anode flow field through an anode flow field exit. A cathode flow field is also defined in fluid communication with the cathode catalyst and with a source of the oxidant for directing flow of the oxidant from a cathode flow field inlet, adjacent the cathode catalyst and out of the cathode flow field through a cathode flow field exit. A macro-pore cathode gas diffusion layer is secured adjacent the cathode catalyst and between the cathode catalyst and the cathode flow field.

The power plant also includes an oxidant pump that is secured to an oxidant inlet line in fluid communication with the oxidant source and with the cathode flow field inlet for selectively varying a flow rate of the oxidant stream into and through the cathode flow field. A thermal management system controls a temperature of the fuel cell and includes a porous coolant plate secured in fluid communication with and adjacent the cathode flow field and the plate is configured to direct a coolant fluid from a coolant plate inlet, through the plate and out of the plate through a coolant plate exit. The coolant plate is also secured in fluid communication with a coolant loop for directing the coolant fluid from the coolant plate exit through the coolant loop, through a coolant pump for circulating the coolant fluid through the coolant loop and plate, through a heat exchanger secured in heat exchange relationship with the coolant loop, through a pressure regulating valve for regulating a pressure of the coolant fluid within the porous coolant plate, and back into the coolant plate inlet.

A primary load is secured in electrical communication through a load circuit and primary load switch with the anode and cathode catalysts for selectively receiving and utilizing electrical current generated by the fuel cell.

The disclosure includes the fuel cell, oxidant pump, and thermal management system configured so that whenever the primary load is receiving electrical current from the fuel cell the oxidant is delivered to the cathode flow field inlet at a pressure of between about 0.58 psig and about 4.4 psig, and, so that the oxidant stream passes through the fuel cell at a stoichiometry of between about 120% and about 180%, and preferably between about 150% and about 170%. Additionally, the power plant may be configured so that a temperature of the oxidant stream adjacent the cathode flow field exit is less than a temperature of the coolant fluid adjacent the coolant plate exit, and so that a temperature of the oxidant stream, adjacent the cathode flow field exit is no more than five degrees Celsius (“° C.”) greater than a temperature of the coolant fluid adjacent the coolant plate inlet.

The porous coolant plate provides a pathway for fuel cell product water to leave the cathode flow field directly into the coolant fluid within the coolant plate instead of into the oxidant stream, thereby facilitating use of such a low oxidant stoichiometry. Additionally, the macro-pore cathode gas diffusion layer produces rapid transport of fuel cell product water away from the cathode catalyst compared to micro pore or micro-pore/macro-pore bi-layers. The macro-pore cathode gas diffusion layer defines pores having an average diameter of between about 15 micrometers to about 40 micrometers. By so efficiently removing product water from the cathode catalyst, the present disclosure provides for an extraordinarily low oxidant stoichiometry, which is also referred to as a very high air or oxygen utilization. (Air or oxygen utilization is the inverse of oxidant stoichiometry.) By providing for a low oxidant stoichiometry and therefore a very low flow rate of the oxidant stream passing through the cathode flow field, a minimal amount of water is removed from the flow field into the oxidant stream. This helps maintain the fuel cell in water balance. This also provides for a very high water balance temperature. A water balance temperature means an air or oxidant exhaust temperature which cannot be exceeded if the fuel cell is to remain in water balance. The present fuel cell power plant, therefore, minimizes requirements for oxidant stream compressors and pumps and related pressure control valves, water recapture apparatus, and/or heat rejection devices, thereby dramatically improving operating efficiencies of the fuel cell power plant.

In a preferred embodiment of the fuel cell power plant, the oxidant stoichiometry is between about 120% and 150%. In a further embodiment, the cathode flow field defines a cathode exit that is adjacent the coolant inlet. This results in a large amount of water condensation in the cathode flow field. However, this is not a problem for the present fuel cell power plant which has porous coolant plates that can remove the condensed liquid water.

Accordingly, it is a general purpose of the present disclosure to provide a fuel cell power plant having improved operating efficiencies that overcomes deficiencies of the prior art.

It is a more specific purpose to provide a fuel cell power plant having improved operating efficiencies that minimizes requirements for oxidant pumps, pressure control valves, water recovery apparatus, heat rejection devices, and related components.

These and other purposes and advantages of the present fuel cell power plant having improved operating efficiencies will become more readily apparent when the following description is read in conjunction with the accompanying drawing.

### BRIEF DESCRIPTION OF THE DRAWINGS

FIG. 1 is a simplified schematic representation of a fuel cell power plant having improved operating efficiencies constructed in accordance with the present disclosure.

FIG. 2 is a simplified, schematic representation of a two-pass cathode flow field showing a flow path of an oxidant stream and a coolant fluid.

FIG. 3 is a graph showing air utilization (the inverse of stoichiometry) of the fuel cell power plant of the present disclosure compared to a prior art fuel cell power plant.

FIG. 4 is a graph showing maximum water balance temperature and oxidant stoichiometry of the fuel cell power plant of the present disclosure compared to prior art fuel cell power plants.

### DESCRIPTION OF THE PREFERRED EMBODIMENTS

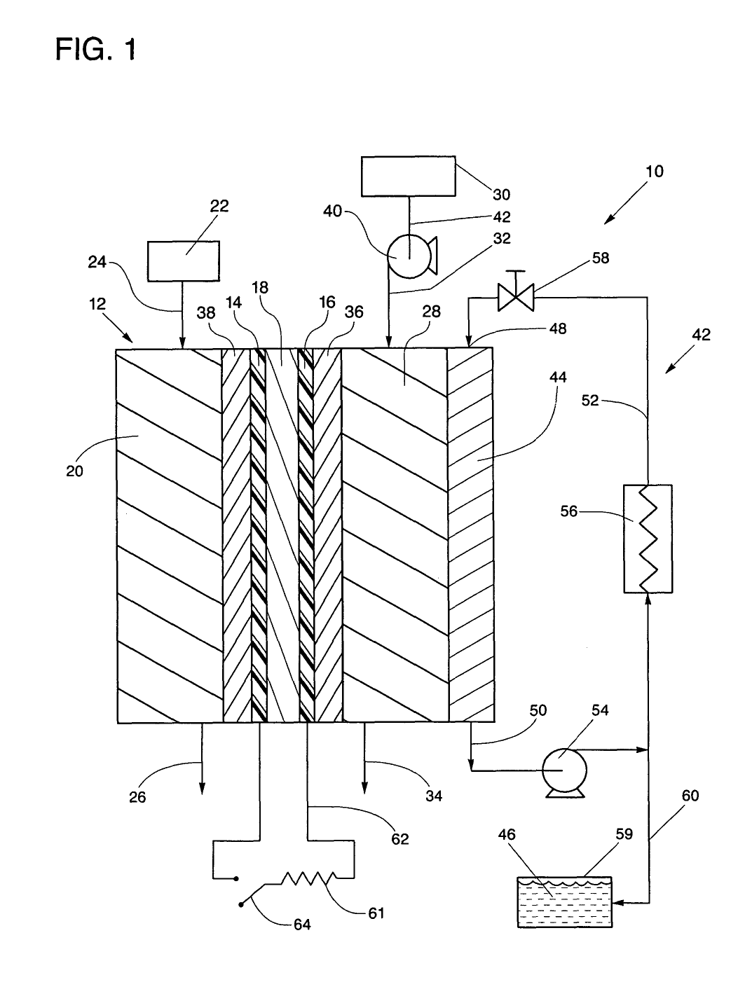

Referring to the drawings in detail, a fuel cell power plant having improved operating efficiencies is shown in FIG. 1, and is generally designated by the reference numeral 10. The power plant includes at least one fuel cell 12 having an anode catalyst 14 and a cathode catalyst 16 secured to opposed sides of an electrolyte 18, such as a proton exchange membrane electrolyte 18. An anode flow field 20 is defined in fluid communication with the anode catalyst 14 and with a source 22 of the hydrogen rich reactant for directing flow of the hydrogen rich reactant from an anode flow field inlet 24, adjacent the anode catalyst 14 and out of the anode flow field 20 through an anode flow field exit 26. A cathode flow field 28 is also defined in fluid communication with the cathode catalyst 16 and with an oxidant source 30 for directing flow of the oxidant from a cathode flow field inlet 32, adjacent the cathode catalyst 16 and out of the cathode flow field 28 through a cathode flow field exit 34. A macro-pore cathode gas diffusion layer 36 is secured adjacent the cathode catalyst 16 and between the cathode catalyst 16 and the cathode flow field 28. A macro-pore anode gas diffusion layer 38 may also be secured between the anode catalyst 14 and the anode flow field 20. The cathode and anode macro-pore gas diffusion layers 36, 38 include a average pore diameter of between about 10 micrometers and about 40 micrometers, a contact angle of greater than 0 degrees and less than about 80 degrees, and a thickness of between about 50 micrometers and about 200 micrometers.

The power plant 10 also includes an oxidant pump 40 that is secured to the oxidant inlet line 42 in fluid communication with the oxidant source 30 and with the cathode flow field inlet 32 for selectively varying a flow rate of the oxidant stream into and through the cathode flow field 28. The “oxidant pump 40” may be any apparatus capable of directing flow of the oxidant reactant stream into the fuel cell 12 at the pressures described herein, including for example a compressed oxidant tank with a pressure regulator (not shown), a blower (not shown), a compressor (not shown), the pump 40, etc.

A thermal management system 42 controls a temperature of the fuel cell 12 and includes a porous coolant plate 44 secured in fluid communication with and adjacent the cathode flow field 28 and the plate 44 is configured to direct a coolant fluid 46 from a coolant plate inlet 48, through the plate 44 and out of the plate 44 through a coolant plate exit 50. The coolant plate 44 is also secured in fluid communication with a coolant loop 52 for directing the coolant fluid from the coolant plate exit 50 through the coolant loop 52, through a coolant pump 54 for circulating the coolant fluid through the coolant loop 52 and plate 44, through a heat exchanger 56 secured in heat exchange relationship with the coolant loop 52, through a pressure regulating valve 58 for regulating a pressure of the coolant fluid within the porous coolant plate 44, and back into the coolant plate inlet 48. The thermal management system 42 may also include an accumulator 59 secured in fluid communication through an accumulator feed line 60 with the coolant loop 52 for storing excess coolant fluid 46.

A primary load 61 is secured in electrical communication through a load circuit 62 and primary load switch 64 with the anode catalyst 14 and cathode catalysts 16 for selectively receiving and utilizing electrical current generated by the fuel cell 12.

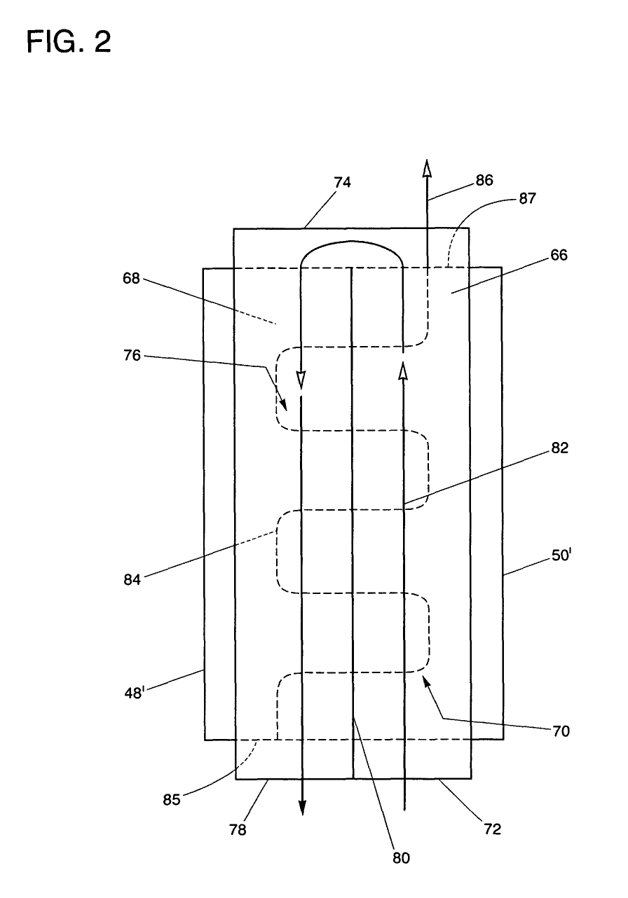

FIG. 2 shows a schematic representation of a two-pass cathode flow field 66 and an adjacent porous coolant plate 68 (shown in hatched lines). The two-pass cathode flow field 66 includes a first pass 70 that directs the oxidant stream from a cathode flow field inlet 72 along the first pass 70 to a turn-around header 74. The two-pass cathode flow field 66 also includes a second pass 76 that directs the oxidant stream from the turn-around header 74 in a direction opposed to the first pass 70 and out of the flow field 66 through a cathode exit 78. The first pass 70 and second pass 76 may be separated within the two-pass cathode flow field 66 by a pass separator 80, and the flow of an oxidant stream through the two-pass cathode flow field 66 is represented by oxidant flow directional arrow 82.

The FIG. 2 porous coolant plate 68 is secured adjacent and in fluid communication with the two-pass cathode flow field 66, such as by pores defined within the plate 68. The plate also includes a coolant flow pathway 84 for directing flow of the coolant fluid 46 through the coolant plate 68 from a coolant inlet 85 in a direction perpendicular to the flow direction 82 of the oxidant stream flowing through the two-pass cathode flow field 66, as represented by coolant flow directional arrow 86. As is apparent from FIG. 2, in a preferred embodiment, the cathode exit 78 is adjacent or over the coolant inlet 85. (The FIG. 1 porous coolant plate 44 and the FIG. 2 porous coolant plate 68 are structured and operate in a manner similar to a “water transport plate” disclosed in U.S. Pat. No. 6,911,275 that issued on Jun. 28, 2005 to Michels et al., which patent is owned by the assignee of all rights in the present disclosure.) The coolant fluid 46 enters the porous coolant plate 68 through a coolant plate inlet 85 adjacent the cathode exit 78 and leaves the coolant plate 68 through a coolant plate exit 87.

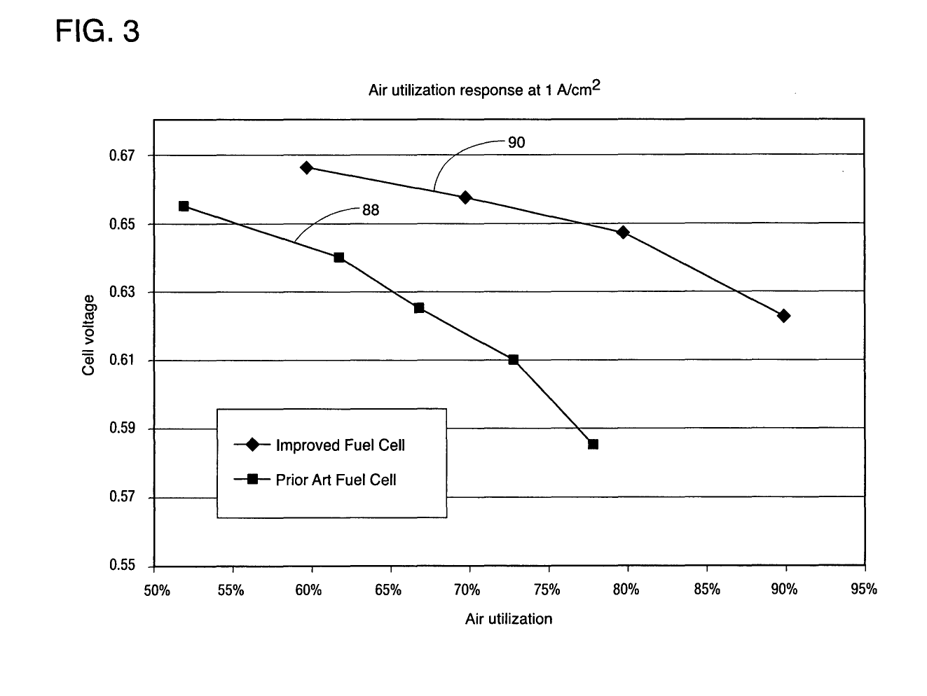

FIG. 3 shows an air utilization (the inverse of oxidant stoichiometry) graph that plots at plot line 88 data showing a rapid decline in cell voltage from about 0.658 volts at 52% air utilization to 0.568 volts about at 78% air utilization. Plot line 88 represents performance of a prior art fuel cell (not shown) having a different cathode macro-pore gas diffusion layer that requires a micro-pore layer. This micro-pore layer retards oxygen transport to the cathode catalyst resulting in diminished fuel cell performance. In contrast, plot line 90 shows dramatically improved performance of a fuel cell 12 constructed in accordance with the present disclosure. In particular, plot line 90 shows that at an air utilization of about 60% cell voltage is about 0.665, and cell voltage only drops off to about 0.622 at an air utilization rate as high as about 90%, which corresponds to an oxidant stoichiometry of about 110%.

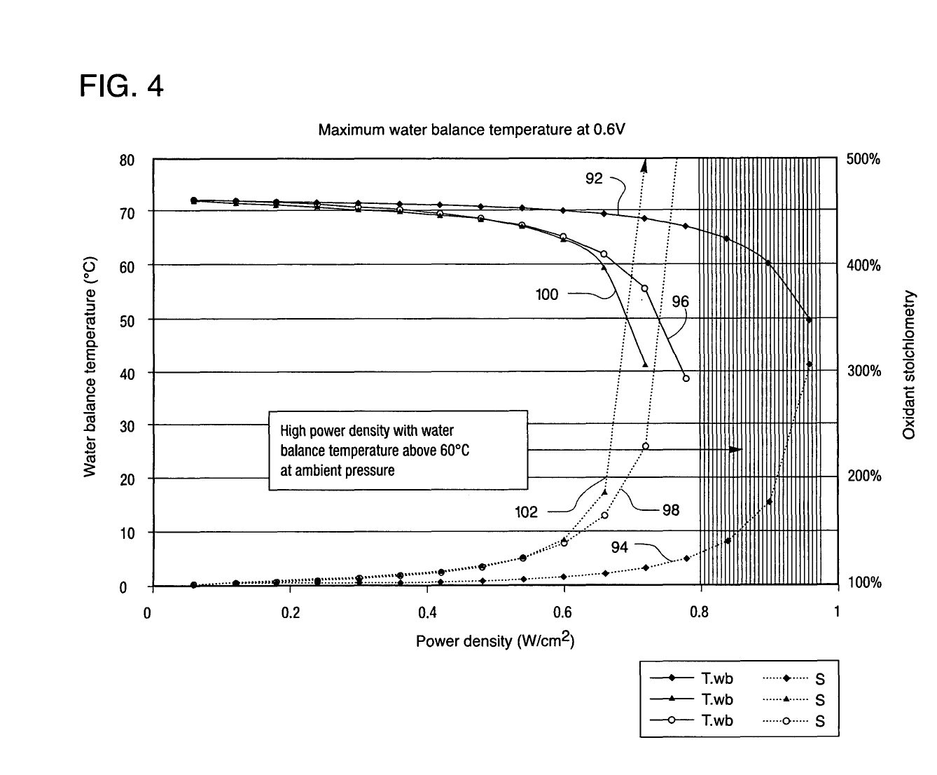

Further data is shown in FIG. 4 comparing at plot line 92 and 94 performance of a fuel cell 12 constructed in accordance with the present invention. It is noted that the solid plot line 92 represents data associated with the left vertical axis of the graph, namely water balance temperature in degree Celsius, while the hatched plot line 94 represents data associated with the right vertical axis of the graph, namely oxidant stoichiometry. The solid plot line 96 and corresponding hatched plot line 98 represent data resulting from tests of a first prior art fuel cell (not shown). The solid plot line 100 and corresponding hatched plot line 102 represent data resulting from tests of a second prior art fuel cell (not shown). Results from tests of the fuel cell power plant 10 of the present disclosure shown in FIG. 4 at plot lines 92 and 94 demonstrate that a maximum water balance temperature at 0.6 volts could be maintained above 70° C. as power density increased from 0.0 watts per square centimeter (W/cm²) to 0.6 W/cm², and as oxidant stoichiometry remained below about 120%. As power density was increased to 0.8 W/cm² the water balance temperature decreased only to about 68° C. while the oxidant stoichiometry increased only to about 130%. Increasing the power density to about 0.86 W/cm² the water balance temperature declined to only about 61° C. while the oxidant stoichiometry increased to only about 175%. In contrast, plot lines 96, 98, and 100, 102, for the two separate prior art fuel cells show dramatically reduced performance. The prior art fuel cells (not shown) included a macro-pore gas diffusion layer that required use of a micro-pore layer (not shown) adjacent to the cathode.

The present disclosure also includes a method of operating the fuel cell power plant 12 for generating electrical current from oxidant and hydrogen rich reactant streams. The method includes the steps of directing flow of the hydrogen rich reactant stream from the hydrogen source 22 through the anode flow anode flow field cell 20 defined adjacent the anode catalyst 14 of the fuel cell 12 and out of the anode flow field 20 through an anode flow field exit 26; directing flow of the oxidant reactant stream from an oxidant source 30 through a cathode flow 28 field defined adjacent the cathode catalyst 16 of the fuel cell 12 and out of the cathode flow field 28 through a cathode flow field exit 34, wherein the oxidant reactant stream enters the cathode flow field 28 at a pressure of between about 0.58 psig and about 4.4 psig, and wherein the flow of the oxidant reactant stream through the cathode flow field 28 is directed at a stoichiometry of between about 120% and about 180%, and preferably between about 150% and about 170%.

The method also includes the steps of directing flow of a coolant fluid 46 through a coolant plate inlet 48 of a porous coolant plate 44, through the plate 44 and directing flow of the coolant fluid out of the plate 44 through a coolant plate exit 50, the porous coolant plate being secured in fluid communication with the cathode flow field 28 for removing heat from the fuel cell 12 and for removing water generated at the cathode catalyst 16 into the porous coolant plate 44. The method may also include the steps of controlling the flow of coolant fluid through the porous coolant plate 44 and removal of water from the cathode flow field 28 through the porous coolant plate 44 so that a temperature of the oxidant stream adjacent the cathode flow field exit 50 is less than a temperature of the coolant fluid adjacent the coolant plate exit 50, and so that a temperature of the oxidant stream adjacent the cathode flow field exit 34 is no more than 5 degrees Celsius greater than a temperature of the coolant fluid adjacent the coolant plate inlet 48. The method also includes the step of directing electrical current generated by the fuel cell 12 through a load circuit 62 to a primary load 61. The method may also include the steps of directing flow of the oxidant stream through a two-pass cathode flow field 66, and securing a macro-pore cathode gas diffusion layer 36 between the cathode flow field 28 and the cathode catalyst 16 and directing the oxidant stream to flow adjacent the macro-pore cathode gas diffusion layer 36.

While the present disclosure has been presented with respect to the described and illustrated fuel cell power plant 10 with improved operating efficiencies, it is to be understood that the disclosure is not to be limited to those alternatives and described embodiments. Accordingly, reference should be made primarily to the following claims rather than the forgoing description to determine the scope of the disclosure.

What is claimed is:

1. A fuel cell power plant (10) for generating electrical current from oxidant and hydrogen rich reactant streams, the power plant (10) comprising:
a. at least one fuel cell (12) including an anode catalyst (14) and a cathode catalyst (16) secured to opposed sides of an electrolyte (18), an anode flow field (20) defined in fluid communication with the anode catalyst (14) and with a source (22) of the hydrogen rich reactant for directing flow of the hydrogen rich reactant adjacent the anode catalyst (14), a cathode flow field (28) defined in fluid communication with the cathode catalyst (16) and with a source (30) of the oxidant reactant for directing flow of the oxidant adjacent the cathode catalyst (16), a cathode gas diffusion layer (36) secured adjacent the cathode catalyst (16) and between the cathode catalyst (16) and the cathode flow field (28);
b. an oxidant pump (40) secured in fluid communication with the oxidant source (30) and with a cathode inlet (32) of the cathode flow field inlet (32) for selectively varying a flow rate of the oxidant into and through the cathode flow field (28);
c. a porous coolant plate (44) secured in fluid communication with and adjacent the cathode flow field (28) and configured to direct a coolant fluid from a coolant plate inlet (48), through the plate and out of the plate through a coolant plate exit (50);
d. a primary load (61) secured in electrical communication through a load circuit (62) and primary load switch (64) with the anode and cathode catalysts (14, 16) for selectively receiving and utilizing electrical current generated by the fuel cell (12); and,
e. the fuel cell (12) and oxidant pump (40) configured so that whenever the primary load (61) is receiving electrical current from the fuel cell (12) the oxidant is delivered to the cathode inlet (32) at a pressure of between about 0.58 psig and about 4.4 psig, and so that the oxidant passes through the fuel cell (12) at an oxidant stoichiometry of between about 120% and about 180%.

2. The fuel cell power plant (10) of claim 1, further comprising the fuel cell (12) and oxidant pump (40) configured so that whenever the primary load (61) is receiving electrical current from the fuel cell (12) a temperature of the oxidant adjacent the cathode flow field exit (34, 78) is less than a temperature of the coolant adjacent the porous coolant plate (44) exit (50, 87), and so that the temperature of the oxidant adjacent the cathode flow field exit (34, 78) is no more than five degrees Celsius greater than a temperature of the coolant adjacent the coolant plate inlet (48, 85).

3. The fuel cell power plant (10) of claim 1, wherein the cathode flow field (66) further comprises a two-pass cathode flow field (66) secured adjacent the porous water transport plate (68) so that a cathode exit (78) of the two-pass cathode flow field (66) is adjacent a coolant plate inlet (85) and so that flow of the oxidant stream through a first pass (70) and a second pass (76) of the two-pass cathode flow field (66) is perpendicular to flow of the coolant fluid through the porous water transport plate (68).

4. The fuel cell power plant (10) of claim 1, wherein the cathode gas diffusion layer (36) is a macro-pore gas diffusion layer (36) that defines a plurality of pores having an average diameter of between about 10 micrometers and about 40 micrometers, a contact angle of greater than 0 degrees and about 80 degrees, and a thickness of between about 50 micrometers and about 200 micrometers.

5. The fuel cell power plant (10) of claim 1, further comprising the porous coolant plate (44) also being secured in fluid communication with a coolant loop (52) for directing the coolant from the coolant plate exit (50) and through the coolant loop (52) through a coolant pump (54) for circulating the coolant through the coolant loop (52) and plate (44), through a heat exchanger (54) secured in heat exchange relationship with coolant loop (52), through a pressure regulating valve (58) for regulating a pressure of the coolant within the porous coolant plate (44), and back into the coolant plate (44).

6. The fuel cell power plant (10) of claim 1, wherein the fuel cell (12) and oxidant pump (40) are configured so that whenever the primary load (61) is receiving electrical current from the fuel cell (12) the oxidant is delivered to the cathode inlet (32) at a pressure of between about 0.58 psig and about 4.4 psig, the oxidant passes through the fuel cell (12) at an oxidant stoichiometry of between about 150% and about 170%.

7. A method of operating a fuel cell power plant (10) for generating electrical current from oxidant and hydrogen rich reactant streams, the method comprising:
a. directing flow of the hydrogen rich reactant stream from a hydrogen source (30) through an anode flow field (20) defined adjacent an anode catalyst (14) of a fuel cell (12);
b. directing flow of the oxidant reactant stream from an oxidant source (30) through a cathode flow field (28) defined adjacent a macro-pore cathode gas diffusion layer (36) secured adjacent a cathode catalyst (16) of the fuel cell (12) and out of the cathode flow field (28) through a cathode flow field exit (34), the macro-pore cathode gas diffusion layer (36) defining a plurality of pores having an average diameter of between about 10 micrometers and about 40 micrometers, a contact angle of greater than 0 degrees and about 80 degrees, and a thickness of between about 50 micrometers and about 200 micrometers;
c. controlling flow of the oxidant reactant stream flowing through the cathode flow field (28) so that the oxidant stream enters the cathode flow field (28) at a pressure of between about 0.58 psig and about 4.4 psig, and so that flow of the oxidant reactant stream through the fuel cell (12) is directed at an oxidant stoichiometry of between about 120 percent and about 180 percent;
d. directing flow of a coolant fluid through a coolant plate inlet (48) of a porous coolant plate (44), through the porous coolant plate (44) and directing flow of the coolant out of the plate through a coolant plate exit (50), the porous coolant plate (44) being secured in fluid communication with the cathode flow field (28) for removing heat from the fuel cell (12) and for removing water generated at the cathode catalyst (16) into the porous coolant plate (44); and,
e. directing electrical current generated by the fuel cell (12) through a load circuit (62) to a primary load (61).

8. The method of operating a fuel cell power plant (10) of claim 7, further comprising controlling flow of the coolant fluid through the porous coolant plate (44) and controlling flow of the oxidant reactant stream through the cathode flow field (28) so that a temperature of the oxidant stream adjacent the cathode flow field exit (34) is less than a temperature of the coolant adjacent the coolant plate exit (50), and so that the temperature of the oxidant stream adjacent the cathode flow field exit (34) is no more than five degrees Celsius greater than a temperature of the coolant adjacent the coolant plate inlet (48).

9. The method of operating a fuel cell power plant (10) of claim 7, further comprising directing flow of the oxidant reactant stream through a first pass (70) and then through an opposed second pass (76) of a two-pass cathode flow field (66) secured adjacent the porous water transport plate (68) so that the oxidant stream exits the two-pass cathode flow field (66) adjacent a coolant plate inlet (85) of the porous coolant plate (68), and directing flow of the oxidant stream through the first pass (70) and the second pass (76) of the two-pass cathode flow field (66) in a direction perpendicular to flow of the coolant fluid through the porous water transport plate (68).

10. The method of operating a fuel cell power plant (10) of claim 7, wherein the step of controlling flow of the oxidant reactant stream further comprises flowing the oxidant stream through the cathode flow field (28) so that the oxidant stream enters the cathode flow field (28) at a pressure of between about 0.58 psig and about 4.4 psig, and so that flow of the oxidant reactant stream through the fuel cell (12) is directed at an oxidant stoichiometry of between about 150 percent and about 170 percent.
